(19) United States
(12) Patent Application Publication
(10) Pub. No.: US 2007/0244786 A1
(43) Pub. Date: Oct. 18, 2007

(54) System and method for the creation and maintenance of fund(s) predominantly comprising insured, FDIC compliant and/or FASB qualified commercial paper

(76) Inventor: Shawn Orr, New Canaan, CT (US)

Correspondence Address: Mitchell A. Stein, Esq.;STEIN LAW, P.C., Suite 4, 24 Woodbine Avenue, Northport, NY, 11768, US

(21) Appl. No.: 11/405,769

(22) Filed: Apr. 18, 2006

(51) Int. Cl. G06Q 40/00

(52) U.S. Cl. 705/36 R

(57) ABSTRACT

A method and system for the creation and maintenance of one or more funds by first creating at least one fund by acquiring insured, non-transferable, FASB qualified commercial paper from at least one provider. The acquired paper is pooled into one or more funds and blocks are created for investment purposes. The blocks are then offered for investment to at least one investor such that each block remains below the statutory insurable limit. Using a computer, reports are generated under an algorithm that calculates all necessary information, including, without limitation, dates of maturity, principal amounts, early withdrawals, dividends, payouts and the like for each investor. The investors are paid, at times by liquidating before maturity. Such liquidity is heretofore unheard of in the industry. The system further includes a time management system for the investors that reports account and portfolio status and permits drawing thereupon, as well as for the providers to view accounts and post new acquisition opportunities.

### FIELD OF THE INVENTION

The present invention relates to the field of systems and methods for investments, and more specifically to pooled investments in a fund that itself invests in insured commercial paper from institutions and the like including, by way of example, certificates of deposit (“CD's”), insured paper (e.g., insured by the National Credit Union Administration (“NCUA”), and other paper that is FDIC/FISB qualified in satisfaction of all legal requirements including those set forth in 12 C.F.R. §330, and sells shares in blocks, limited partnerships and the like (all “commercial paper”) to purchasers for rates of return and liquidity, all as more fully explained hereinbelow.

### BACKGROUND OF THE INVENTION

In finance, investment funds (like mutual funds) are heretofore well known vehicles by which an investment company or trust maintains a fluid capital stock. It has held a unique place in the investment community in that the fund, itself, can at any time sell or redeem any of its outstanding shares at net asset value (i.e., the price of a share equals total assets minus liabilities divided by the total number of shares). A mutual fund purchases and thereby owns the securities of other entities, typically corporations, and receives dividends or the like on the shares that it holds.

In typical fashion, the earnings of a mutual fund (minus the costs involved in its operation and the like) are distributed to its investors, or holders of the shares in the funds. The idea is to spread risk. In other words, the fund receives investment capital and invests in a multiplicity of stock in corporations such that even if one declines, another increases in value such that the fund makes money and distributes to the investors. The investors in mutual funds thus gain the advantage of diversification, which might ordinarily be beyond their means, by simply purchasing shares in the fund.

It is known in the art that mutual funds, often provide skilled management for security holdings, but are limited to stock, bond, balanced, index, and money-market funds. Stock funds mainly invest in common shares, and bond funds in bonds; such funds may specialize in a particular category of stocks or bonds (such as Internet stocks or municipal bonds). A balanced fund might invest in preferred stocks and bonds in addition to common stocks. Index funds invest in a portfolio that mimics a given index, such as the stocks that make up the S&P 500. Thus, despite the risks, mutual funds provide retail investors with diversification, liquidity, professional portfolio management, institutional purchasing power, efficient clearing structures, convenient access, and federal oversight. So, while lacking in insurance against catastrophic loss, the mutual fund operates under the oversight of the SEC and NASD.

Of the problems associated with the mutual fund mechanism are the dependency on the volatility of the market that such funds are in. For example, where a fund is invested in high-risk, potential high-yield, corporate stock, if the market is driven downwardly, the investors in the fund lose as well. Indeed, some funds reach the point of insolvency, always a risk factor, in which instance the investors loses the investment principal, as well as any dividends not removed prior to the occurrence of insolvency.

Funds are managed by management companies, as stated above, who primarily seek to disclose the risk factors and spread the risk. Yet the risk is forever present that another “Black Monday” may hit and the dependency on the stock market reduces or eliminates the fund.

Likewise, there have not been any significant advancements in the CD industry in the last twenty years. Banks may offer new CD products, but remain constrained by the FDIC problems, indicated hereinbelow. Thus, the CD market has been traditionally underutilized, illiquid, opaque and fragmented.

It should also be appreciated that the CD industry suffers from widespread inefficiencies and redundant service structures. The “one-on-one” sales to bank customers as investors, lack of liquidity, federal deposit insurance limitations and the static rate structures render CD's not only boring as an investment, but generally of limited utility.

It is one of the objects of the instant invention to reduce the risk involved to the investor while creating one or more funds that have a calculable, preserved and insured yield and a pronounced liquidity, thereby preventing the investor from losing the principal investment while providing access to funds prior to the date of maturity of the underlyings.

Insured commercial paper is known in the field and used by banks in a number of fashions. For example, the traditional certificate of deposit is a deposit made with a bank, credit union, or savings and loan institution. The deposit is a specified amount that is deposited for a certain period of time at a set interest rate. There are no fees on CD's, but a penalty is charged for early withdrawal. In short, an investor purchases a CD for a fixed face value, term and an interest rate, and either awaits the maturity at term, or withdraws early at a penalty.

The FDIC—short for the Federal Deposit Insurance Corporation—is an independent agency of the United States Government. The FDIC protects investors against the loss of deposits if an FDIC-insured bank or savings association fails. FDIC insurance is backed by the full faith and credit of the United States government. The FDIC insures deposit accounts such as checking, NOW and savings accounts, money market deposit accounts, and certificates of deposit (CD's). Yet, the basic insurance limit is $100,000 per depositor per insured bank.

As reported by the FDIC, the United States market for CD's, as of Sep. 30, 2004 stood at nearly $1.7 trillion (excluding NACU institutions, discussed below), partitioned into retail (denomination of up to $100,000) and institutional (denominations of greater than $100,000). It is generally recognized that investors purchase CD's because of assured interest income (the CD has a fixed rate and term), principal protection (FDIC/NACU) and strict federal regulation through the banking system.

The National Credit Union Administration (“NCUA”) is the federal agency that charters and supervises federal credit unions and insures savings in federal and most state-chartered credit unions across the country through the National Credit Union Share Insurance Fund (NCUSIF), a federal fund backed by the full faith and credit of the United States Government. There are limits to NCUA that mimic those of FDIC, and hence an investment greater than the limit is vulnerable to loss, as it not insured.

Likewise, other paper, that is qualified under the Financial Accounting Standards Board (“FASB”) and protected under 12 C.F.R. §330, et seq., providing the declaration of a par value of $1, is also known, but heretofore not made available in the manner herein described.

It is thus an object of the instant invention to take advantage of an insurable instrument to one or more fund(s) for acquisition, to provide an investor an opportunity to invest in blocks and quantities that exceed the typical $100,000 cap, thereby maintaining the investor's principal investment and providing a predicted date of maturity, interest and payment.

It is also another object of the instant invention to provide one or more fund(s) that permit an investor insurance protection for the investment, while allowing liquidity at a minimal charge.

It is still another object of the instant invention to provide a system and method whereby banks and other styled institutions (generally styled “banks” herein) can have a “one stop shop” wherein commercial paper can be sold and acquired without the need to interface one-on-one with individual investors.

These and other objects of the instant invention are achieved as described in greater detail hereinbelow.

### SUMMARY OF THE INVENTION

The various features of novelty which characterize the present invention are expressly and unambiguously delineated in the claims annexed to and forming part of the disclosure. For a better understanding of the present invention, its practical advantages, and specific objects attained by its use, reference should be had to the drawings and descriptive matter in which there are illustrated and described preferred embodiments of the invention.

In the instant invention, there is provided a method for the creation and maintenance of one or more funds by first creating at least one fund by acquiring insured, non-transferable, FASB qualified commercial paper from at least one provider. The acquired paper is pooled into one or more funds and blocks are created for investment purposes. The blocks are then offered for investment to at least one investor who can purchase shares in one or more blocks. It should be appreciated that, in this manner, an investor can purchase shares in multiple blocks in multiple funds comprising multiple paper wherein each alone does not overcome the statutory insurable limit. Thus, an investor's investment principal is protected by law, although the total amount of investment, if summed is greater than the limit would have been had the investor simply purchased one item of commercial paper or placed money in but one bank.

A block position in each of said at least one fund is thus created for each investor who is accepted into the fund.

Likewise, using a computer, reports are generated under an algorithm that calculates all necessary information, including, without limitation, dates of maturity, principal amounts, early withdrawals, dividends, payouts and the like for each investor. The investors are paid, at times by liquidating before maturity. Such liquidity is heretofore unheard of in the industry.

Of course, at all times the total amount of each block investment per investor is below the insurable limit.

Thus, it can be observed that the investor has the option of selecting from the group consisting of: dividends paid for said commercial paper; payout upon maturity of the commercial paper; and earlier than maturity at the election of the investor (in other words, liquidity).

All steps in the process probably involve a fee of some sort, depending upon the status of the investor and the funds.

Also, feeder banks are involved that provide commercial paper to a plurality of funds such that no investor exceeds the limit of insurability despite the amount of principal invested in said plurality of funds. This way many funds are established, many blocks are sold, but no individual block ever exceeds the insurable limit.

The investors are selected from the group consisting of individual investors, educational investors, health care investors and institutional investors.

The system involves each of the foregoing, as well, including acquisition by the fund(s) of insured, non-transferable, FASB qualified commercial paper from providers, pooling of all the acquired paper; offering investment to investors of block position(s) in each of the fund(s), accepting investments, reporting via a computer-generated algorithm for providing reports to both providers and investors of their positions, and, obviously, payments to the investors after receipt from the providers.

The system further includes a trade management system (“TMS”) for the investors that reports account and portfolio status and permits drawing thereupon, as well as for the providers to view accounts and post new acquisition opportunities.

Other features will become apparent from reading the disclosure and claims of the instant invention.

### BRIEF DESCRIPTION OF THE DRAWINGS

In the drawings, wherein similar reference characters denote similar elements throughout the several views:

FIG. 1 is an overall flow chart view of the integration of investors and banks via one or more fund(s) in accordance with the preferred embodiment of the subject invention;

FIG. 2 is a flow diagram showing the electronic fund transfer system “EFTS” of the subject invention in particular relation to Mutual Funds and maturity, in accordance with the preferred embodiment of the subject invention;

FIG. 3 is a diagrammatical representation of investors and types of accounts in the EFTS method and system in accordance with the preferred embodiment of the subject invention;

FIG. 4 is a flow chart of a portion of the EFTS showing investor options in accordance with the preferred embodiment of the subject invention;

FIG. 5 is a flow chart of a portion of the EFTS showing how insured providers (herein also referred to as banks, as the terms are, for purposes of the subject invention, synonymous), in accordance with the preferred embodiment of the subject invention; and

FIG. 6 shows the interplay between feeder banks and fund(s) in accordance with the preferred embodiment of the subject invention.

### DETAILED DESCRIPTION OF THE PREFERRED EMBODIMENTS

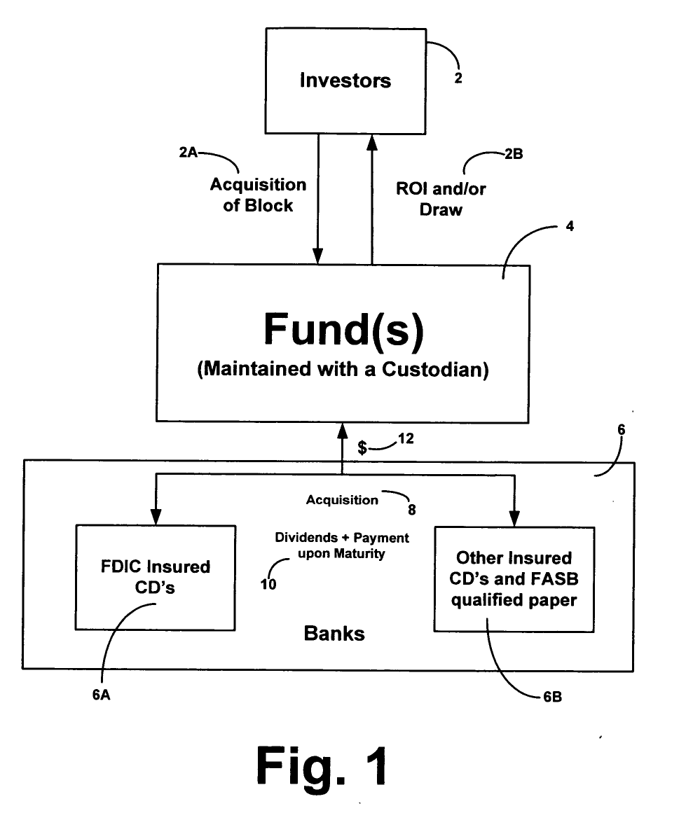

As shown in FIG. 1, the present invention is directed to a method and system for providing investors 2 with an opportunity to invest in one or more funds 4 via acquisition of at least one block 2A by purchase, in exchange for which, investors 2 receive a return on their investment and/or a draw 2B.

It should be understood and appreciated by one of ordinary skill in the art that the fund(s) are managed by a separate management company that acquires at step 8 from institutions like banks 6, FDIC Insured CD's 6A or other insured CD's, and FASB qualified paper 6B. The fund(s) 4 are maintained in a custodian bank as shown in 4. That which is acquired from banks 4 involve the payment of dividends and payment upon maturity at step 10, and hence involve money 12 in both acquisition and payback.

The system and method herein provides (as shown in greater detail hereinbelow) a computer-operated EFTS whereby banks can provide that which they have to offer for acquisition, and investors can determine how to control their portfolios. In exchange, there is a fee charged by the management company for its provision of services, some of which may be derived from the acquisition of one or blocks at step 2A or by dividends as they are paid prior to or at maturity at step 10.

It is the intent of find(s) 4 to acquire a multiplicity of commercial paper that is insured to thereby provide a number of benefits to both the banks 6 and investors 2. Most unusual to the subject invention is the fact that all of the underlyings (i.e., that which has been acquired and added to fund(s) 4 are themselves insured commercial paper. In other words, there is no risk to the investor of the principal investment (unless there is early withdrawal via too great a draw at step 2B), but otherwise, by combining the best attributes of the CD market and the fund industry (principally but not exclusively mutual funds), the insured fund(s) thereby created provide the safety of insurance of the principal with the liquid efficiencies of the securities market.

Thus, it is observable that the subject invention provides investors with total principal protection utilizing pass-through insurance (provided investors do not overdraw at step 2B), liquidity (in that drawing can occur without penalty, but with a modicum of costs associated therewith), low management fees and professional portfolio management. For banks (including credit unions and the like), the subject invention dramatically enhances the breath and width of the CD and other insured commercial paper markets as a source of capital funding.

It should be noted that the subject invention creates enhanced operating efficiencies, as well, thereby reducing redundancy and costs. For example, banks can sell entire groups of investment-grade, insured commercial paper to but one location, thereby minimizing the need to have bankers as salesmen or to advertise in a multiplicity of markets simply to sell CD's. Thus, banks are enhanced in that they are given cost efficient and faster access to CD funding, lower issuance fees, asset/liability management efficiencies, cost savings associated with simplified account maintenance, a new and stable low cost source of funds for community and regional banks that cannot normally participate in the national market and, of course, Patriot Act Compliance.

Likewise, investors do not need to watch a multiplicity of insured commercial paper that they have acquired (or the paperwork monthly statements), for, as shown below, the EFTS system provides a portal for all such information to be visually seen and decisions to be made, liquidity provided in a heretofore illiquid environment. As a result of the size of the fund(s), the costs to the investor are also greatly reduced.

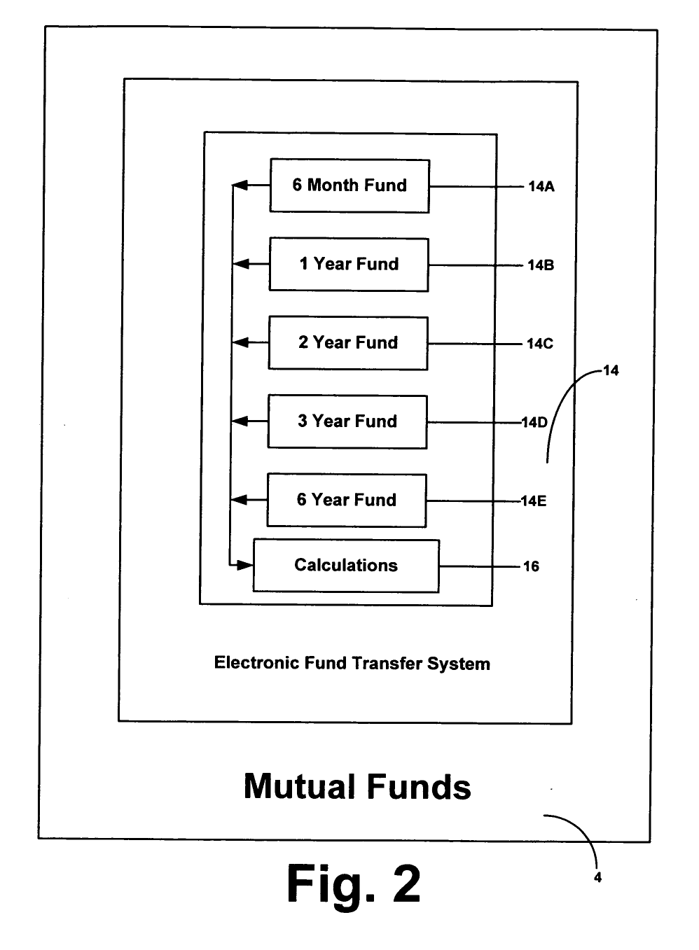

As shown in FIG. 2, an example of a Mutual Fund 4 is indicated utilizing the EFTS with a multiplicity of CD's, such that the fund, in this example is broken into categories of a 6 month fund 14A, 1 year fund 14B, 2 year fund 14 C, 3 year fund 14D, and 6 year fund 14 E. Calculations for each are made at step 16, and handled by the EFTS. Obviously, the longer the term, generally the greater the return. However, this FIG. 2 shows that, for the first time, a multiplicity of insured instruments having different dates of maturity are combined into one single mutual fund, while preserving the pass-through insurance to the investors.

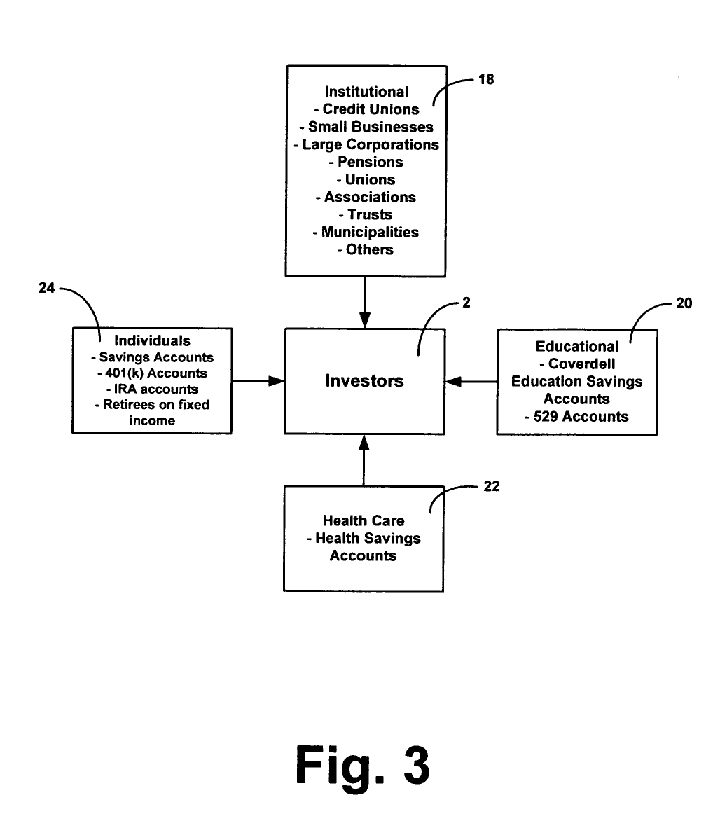

As is observable, the instant invention provides investors with the opportunity to invest in at least one multi-tranche (fixed income) fund that invests in insured commercial paper, like CD's. As indicated, the method and system herein described provides an investor with a rapid and simplified means of investing in and establishing a diversified portfolio of insured instruments. Also, by pooling investors and their proceeds, higher yields can be captured as negotiations with banks become greater than the typical one-on-one situation that has preceded the advent of the instant invention. Thus, FIG. 3 shows a list of investors 2, that include individuals 24 (and their savings accounts, 401(k) accounts, IRA accounts, retirees on fixed income and the like), institutional investors 18, like credit unions, small businesses, large corporations, pensions, unions, associations, trusts, municipalities, and others, educational investors 20 like Coverdell Education Savings Accounts and 529 accounts, and health care investors 22, including health savings accounts. This list is by no means exhaustive, but exemplifying the diversity apparent in the method and system herein.

Among individual investors, it is anticipated that a primary market will comprise retirement savings accounts due to a preference inherent in such accounts towards high-quality, short-term investments such as stable-value funds, which offer safety of principal and stable returns. The instant invention should thus assist in revitalizing the stable-value funds which are otherwise declining as such funds succumb to regulatory pressure regarding the mechanism of operation and structure making the necessary calculation of NAV very difficult. As a result of the decline in the market heretofore experienced, many investment companies have closed such funds, sought to rename them, or merged them out of existence. This is demonstrative of an overall problem that the instant invention seeks to overcome—the rapidly aging population and the necessity for an investment vehicle that meets or exceeds the needs. The flexibility, limited costs, liquidity and other aspects of the instant invention provide such an answer.

As stated above, it should be appreciated that an investor does not purchase directly into a CD or other instrument, but rather purchases one or more “blocks” in the fund(s). Thus each investor owns a pro rata share in the block, and each investor is insured up to $100,000 in that block. For example, if ten people pool $50,000 with each owning a 1/10th share ($5,000) and purchase a $50,000 CD from an ABC Bank, each member of the block CD would be insured up to $100,000. In this example, each member of the block has only utilized 5% of that member's total pass through insurance. Further each member/investor (synonymous for these purposes) could have placed $100,000 into the block with a total block size of $1,000,000, and while maintaining the same FDIC/NUCA insurance in the example ABC Bank.

One of ordinary skill in the art, familiar with the rules set forth in, e.g., 12 C.F.R. §330, would well recognize, in light of the subject invention, that the fund is able to achieve FDIC insurance through a principle known as pass-through insurance. Pass-through insurance enables custodians, trusts, pensions and escrowed accounts to place more than the FDIC insurance deposit limit into any one bank and retain FDIC insurance protection. To be eligible for insurance coverage the “custodian” herein will maintain adequate books and records reflecting ownership—which is not only in satisfaction of the legal requirement but provides ease of management under the Trade Management System (“TMS”), a portion of the instant method and system, described hereinbelow.

In addition to pass through insurance, the instant fund(s) allow block placements to maintain full FDIC/NUCA (or other) insurance protection, pass-through insurance enabling liquidity for the investor. Since the TMS system, as described hereinbelow, and its underlying accurate and complete books and records are maintained for ownership of each investor in accordance with legal mandates, there is a similarity to SEC and NASD type requirements, such that like custodial maintenance of stock positions, the TMS portion of the instant invention allows the fund to replace ownership or otherwise cover where an investor seeks to withdraw funds risking, but not necessarily receiving a early withdrawal penalty (“EWP”), all as more fully described hereinbelow.

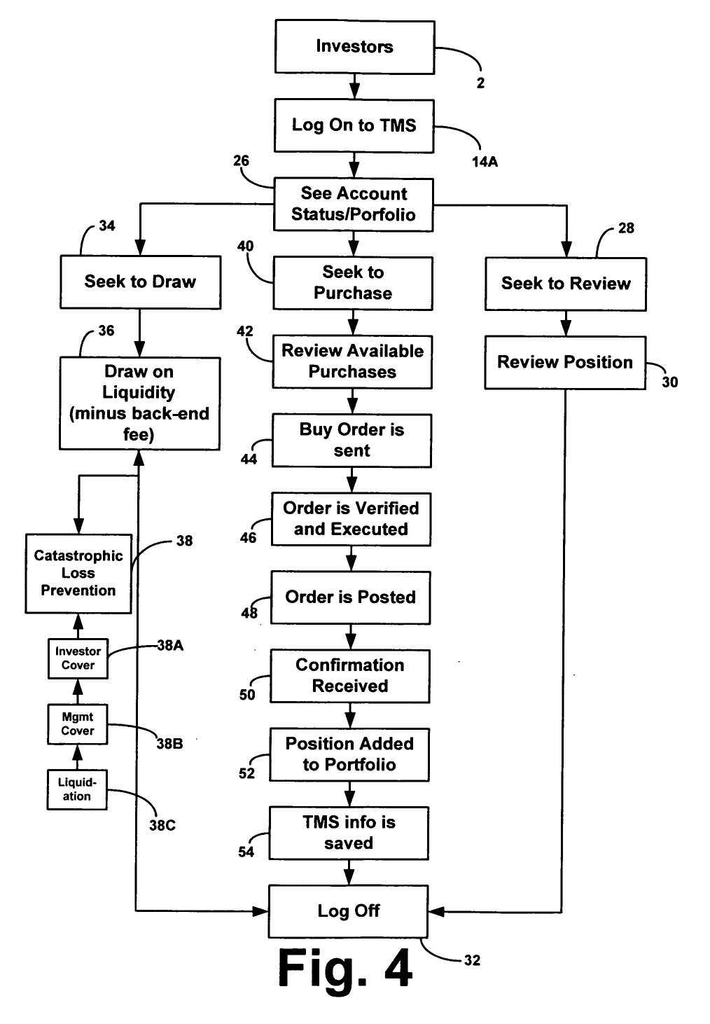

Thus, directing attention to FIG. 4, there is revealed investors 2 access via logon to TMS at step 14A. Once logged on, there are options available to the investor. First, the investor is given an overall view of the accounts status/portfolio at step 26. This will show investments, terms, returns, dividends, EWP's, and the like, essentially providing a full description of the investor's position.

In FIG. 4, the simplest step is for the investor to seek to review at step 28 the portfolio position, review the position at 30, decide that no action is required and log off at step 32.

In FIG. 4, a more complicated approach is provided where the investor seeks to place an investment. In this instance, the investors seeks to purchase at step 40 by reviewing purchase options at step 42. It should be appreciated that purchase options, controlled by the management company, include all blocks available, which may include those that another investor is seeking to sell, as described hereinbelow, or new products, or other available purchases that may be present. If the investor elects, a buy order is sent via step 44. The order is verified and executed at step 46 (which may take some time, e.g., seven days depending upon the selection and availability). Once executed, the order is posted at step 48, confirmation received at step 50, the position is added to that investor's portfolio at step 52, the TMS information is saved at step 54 and log off occurs at step 32.

In FIG. 4, the investor is provided the opportunity to draw at step 34. This liquidity, heretofore unknown in the context of insured, commercial paper, allows the investor to draw on liquidity via step 36. It should be appreciated that the inventive method and system provides for catastrophic loss prevention at step 38 (as in a “run” on the entire series of fund(s), or simply a sale that is prior to full term of an instrument. In this case, three examples of protection are afforded. For example, another investor can cover via step 38A, it being understood that the dynamic nature of the TMS system shown in FIG. 4 provides a purchase of that which is being liquidated, thereby substituting one investor for another. Likewise, management can cover at step 38B via a credit line or other device, or simply by excess funds that may be available. Lastly, liquidation can occur via step 38C, in which case full distribution of the underlying occurs, with EWP, if required.

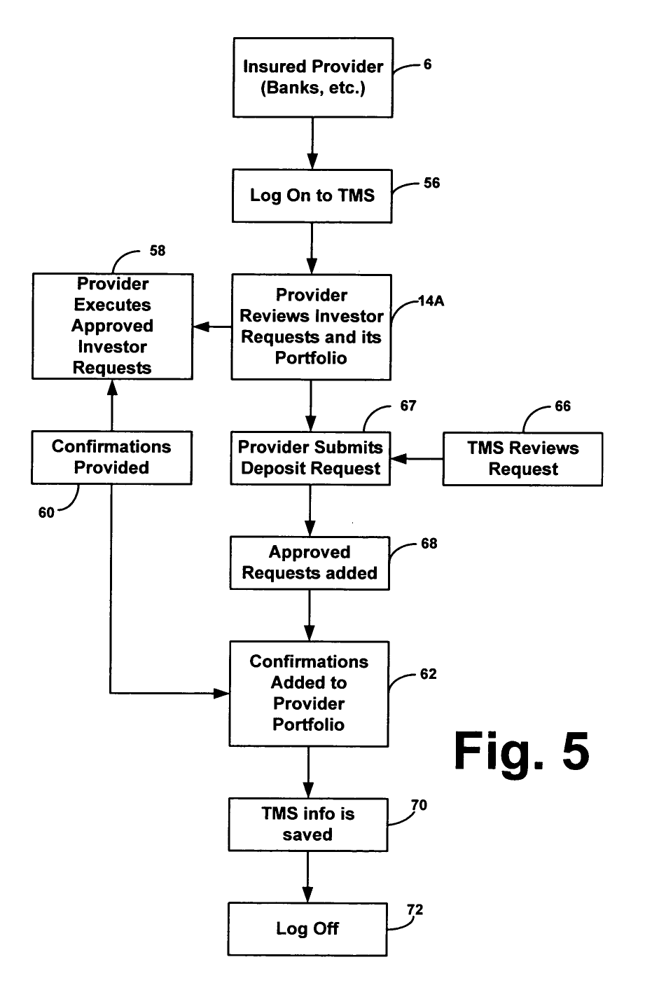

As shown in FIG. 5, just as an investor can log on to the TMS, so, too can insured providers like banks, etc. at box 6, via step 56. Once the provider logs on, the provider can review each investor's request to buy or sell and each investor's portfolio with that institution at step 14 A. If there is a buy or sell order, the provider executes (if approved) the investor requests at step 58, confirmations are provided at step 60, and then added to the provider portfolio at step 62.

Also as shown in FIG. 5, the provider 6 can provide new offerings via a deposit request of the new offering at step 67. Obviously, the TMS must first approve the request before it is given via step 66. Approved requests are then added to the portfolio for acquisition at step 68. Confirmations are added to provider portfolio (when a purchase of approved requests occur) at step 62, the TMS info is saved at step 70, and log off occurs at step 72.

It should be appreciated that the TMS shows both dynamic and static information, such that when an investor logs in (like in FIG. 4), the actual EWP or backend fee, as the case may be, is also shown, so the investor can see the impact on his or her portfolio. It should also be appreciated that dividends may be paid at a slower rate to the investor accounts even if earned at a faster rate from the banks in order to provide the management with necessary operating capital at a minimum of cost.

In sum, the TMS, among things, retains the investor profile and provides access, tracks investor positions for pass-through insurance to ensure that no investor ever has more than $100,000 in any bank at any time in order to be eligible for pass-through insurance, funds can be tracked anywhere and at any time, accrued interest, the network will be secure for purchases, and audited hard copies can be created.

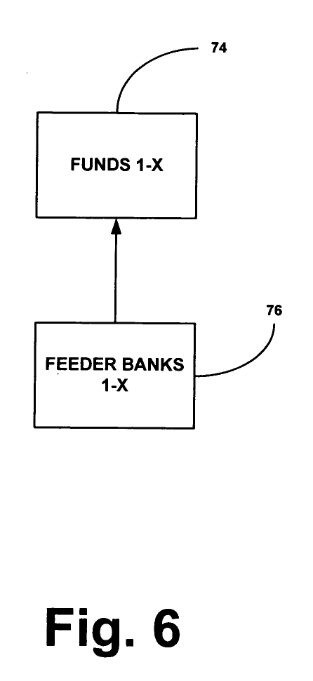

Lastly, FIG. 6 shows the interplay between funds 1-X 74 and feeder banks 1-x 76. The reason for this is for the TMS and EFTS to ensure that in no instance does an investor's portfolio exceed the maximum amount of insurance. Thus, by breaking up the funds and the feeder banks to the funds, this can be achieved.

While there have shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the invention, therefore, to be limited only as indicated by the scope of the claims appended hereto.

I claim:

1. A method for the creation and maintenance of at least one fund comprising:
(a) acquisition by the at least one fund of insured, non-transferable, FASB qualified commercial paper from at least one provider by the at least one fund;
(b) pooling said commercial paper in the at least one fund;
(c) offering for investment to at least one investor a block position in each of said at least one fund;
(d) accepting at least one investment by said at least one investor in the at least one fund;
(e) providing reporting means via a computer-generated algorithm for each of said at least one provider and each of said at least one investor of acquisition(s) and investment(s); and
(f) paying said at least one investor.

2. The method of claim 1, wherein the total amount of said investment is below the insurable limit.

3. The method of claim 1, wherein said paying of said at least one investor is selected from the group consisting of: dividends paid for said commercial paper; payout upon maturity of the commercial paper; and earlier than maturity at the election of the investor.

4. The method of claim 3, wherein said paying at earlier than maturity involves a fee.

5. The method of claim 1, wherein said investment involves a fee.

6. The method of claim 1, wherein said at least one provider involves feeder banks that provide said commercial paper to a plurality of funds such that no investor exceeds the limit of insurability despite the amount of principal invested in said plurality of funds.

7. The method of claim 1, wherein said investors are selected from the group consisting of individual investors, educational investors, health care investors and institutional investors.

8. A system for the creation and maintenance of at least one fund, comprising:
(a) acquisition means by the at least one fund of insured, non-transferable, FASB qualified commercial paper from at least one provider by the at least one fund;
(b) pooling means for said commercial paper in the at least one fund;
(c) offering means for offering investment to at least one investor a block position in each of said at least one fund;
(d) accepting means for accepting at least one investment by said at least one investor in the at least one fund;
(e) reporting means via a computer-generated algorithm for providing reports to each of said at least one provider and each of said at least one investor of acquisition(s) and investment(s); and
(f) paying means for paying said at least one investor.

8. The system of claim 8, wherein the total amount of said investment is below the insurable limit.

9. The system of claim 8, wherein said paying means of said at least one investor is selected from the group consisting of: dividends paid for said commercial paper; payout upon maturity of the commercial paper; and earlier than maturity at the election of the investor.

10. The system of claim 8, wherein when said paying means occurs at earlier than the maturity, a fee is involved.

11. The method of claim 8, wherein said investment means involves payment of a fee.

12. The method of claim 8, wherein said at least one provider involves feeder banks that provide said commercial paper to a plurality of funds such that no investor exceeds the limit of insurability despite the amount of principal invested in said plurality of funds.

13. The system of claim 8, wherein said investors are selected from the group consisting of individual investors, educational investors, health care investors and institutional investors.

14. The system of claim 8, further comprising a time management system for the at least one investor, comprising:
(a) reporting means for viewing account status and portfolio;
(b) drawing means for drawing down upon the money invested; and
(b) reviewing means for reviewing the status of the investor's account.

15. The system of claim 8, further comprising a time management system for the at least one provider, comprising:
(a) reporting means for reviewing investor requests and portfolios;
(b) submission means for submitting additional commercial paper for acquisition; and
(c) confirmation means for determining the status of said requests, portfolios and additional submissions.
